(19) United States
(12) Patent Application Publication
(10) Pub. No.: US 2007/0052631 A1
(43) Pub. Date: Mar. 8, 2007

(54) Electron emission display device and driving method thereof

(76) Inventor: Chul Ho Lee, Cheonan-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/481,777

(22) Filed: Jul. 5, 2006

(30) Foreign Application Priority Data
Sep. 8, 2005 (KR) 10-2005-83890

(51) Int. Cl. G09G 3/20

(52) U.S. Cl. 345/74.1

(57) ABSTRACT

Disclosed are an electron emission display device and a driving method thereof capable of elevating a luminance and enhancing its lifetime. A pixel portion displays an image corresponding to voltages of a first electrode and a second electrode. A data driver transfers a data signal to the first electrode. A scan driver transfers a scan signal to the second electrode. A current measuring section measures an emission current flowing through the pixel portion. A power supply unit outputs an electric drive source. A voltage controller changes a voltage of an electric drive source corresponding to the emission current measured by the current measuring section. The voltage controller controls the emission current flowing through the pixel portion by the changed voltage of the electric drive source, so that a magnitude of the emission current is less than that of an initially set emission current.

### CROSS-REFERENCE TO RELATED APPLICATIONS

This application claims the benefit of Korean Patent Application No. 10-2005-83890, filed on Sep. 8, 2005, in the Korean Intellectual Property Office, the disclosure of which is incorporated herein by reference.

### BACKGROUND OF THE INVENTION

1. Field of the Invention

The present invention relates to an electron emission display device and a driving method thereof. More particularly, the present invention relates to an electron emission display device and a driving method thereof, which compensate for a luminance drop in order to improve the life thereof.

2. Description of the Related Technology

Recently, flat plate displays such as a liquid crystal display (LCD), plasma display panel (PDP), electro luminescent display (ELD), or electron emission display (EED) have been developed. Among the flat plate displays, an electron emission display device includes an electron emission device. An electron emission display device may also be referred to as a field emission display (FED) device. The electron emission device has an electron emission region and an image expression region. The electron emission region is a region for emitting electrons. In the image expression region, the electrons emitted from the electron emission region collide with a fluorescent layer to emit light. The electron emission display device has advantages such as high image quality, high resolution, wide viewing angle, lightweight, thinness, and low power consumption.

In general, there are electron emission devices of a heat emission type and a cold cathode type, which use a heat cathode and a cold cathode, respectively, as an electron source. In electron emission devices of a heat emission type, a high voltage is applied to heat the cathode to a high temperature for emitting electrons. On the other hand, electron emission devices of a cold type do not need heating to a high temperature and can emit electrons even at a low voltage.

Various other types of electron emission devices of the cold cathode type are available: for example, a field emitter array (FEA) type, a surface conduction emitter (SCE) type, a metal-insulator-metal (MIM) type, a metal-insulator-semiconductor (MIS) type, and a ballistic electron surface emitter (BSE) type.

An FEA type electron emission device emits electrons due to an electric field difference in a vacuum by using materials with a low work function or a high β function. An FEA type electron emission device uses a tip structure having a shape-pointed front end, carbon system materials, or nano materials as an electron emitting source.

In an SCE type electron emission device, a conductive thin film is formed on a substrate between two electrodes facing each other. Incurring a minute crack in the conductive thin film forms an electron emitting portion. The SCE type electron emission device applies a voltage to an electrode to flow an electric current through a surface of the conductive thin film. Electrons are emitted from the electron emitting portion.

In an MIM type electron emission device, an electron emitting portions with an MIN structure is formed. When a voltage is applied to two metals positioned at intervals of an insulator, electrons are moved and accelerated from a metal having a higher electron potential to a metal having a lower electron potential to be emitted.

In an MIS type electron emission device, an electron emitting portion with an MIS structure is formed. When a voltage is applied to a metal and a semiconductor positioned at intervals of an insulator, electrons are moved and accelerated from a semiconductor having a higher electron potential to a metal having a lower electron potential to be emitted.

In a BSE type electron emission device, an electron supply layer composed of a metal or semiconductor is formed on an ohmic electrode, based on the following principle. Electrons travel without dispersion when a size of a semiconductor is reduced to a size range less than a mean free path of an electron in the semiconductor. An insulation layer and a metal thin film are formed on the electron supply layer. By applying a power source to the ohmic electrode and the metal thin film, electrons are emitted.

The electron emission device has advantages of self-light source, high efficiency, high luminance, wide luminance region, natural color, high color purity, and wide view angle. In addition, it has wide operation speed range and an operation temperature range. Accordingly, the electron emission device is applicable to various fields and has been actively studied.

FIG. 1 is a block diagram illustrating a conventional electron emission display device. With reference to FIG. 1, the conventional electron emission display device includes a pixel portion 10, a data driver 20, a scan driver 30, a timing controller 40, and a power supply unit 50.

The pixel portion 10 includes pixels 11. In the pixel portion 10, a plurality of cathode electrodes C1, C2 . . . , Cn are arranged in a row direction. A plurality of gate electrodes G1, G2 . . . , Gn are arranged in a column direction. In addition, electron emission sections are provided at intersections of the cathode electrodes C1, C2 . . . , Cn and the gate electrodes G1, G2 . . . , Gn. Alternatively, the cathode electrodes C1, C2 . . . , Cn and the gate electrodes G1, G2 . . . , Gn may be arranged in column and row directions, respectively. Hereinafter, it is assumed that the cathode electrodes C1, C2 . . . , Cn are arranged in a row direction, and the gate electrodes G1, G2 . . . , Gn are arranged in a column direction.

The data driver 20 generates a data signal using an image signal, and transmits the data signal to the cathode electrodes C1, C2 . . . , Cn. The data driver 20 generates an electrode signal for turning on/off the pixels 11 formed at the intersections of the cathode electrodes C1, C2 . . . , Cn and the gate electrodes G1, G2 . . . , Gn.

The scan driver 30 is connected to the gate electrodes G1, G2 . . . , Gn, and selects one of the plurality of the gate electrodes G1, G2 . . . , Gn, and transmits the data signal to the pixel portions 11 connected to the selected gate electrode.

The timing controller 40 transmits a data driver control signal and a scan driver control signal to the data driver 20 and the scan driver 30 to control the data driver 20 and the scan driver 30, respectively. The power supply unit 50 supplies power to the pixel portion 10, the data driver 20, the scan driver 30, and the timing controller 40.

In the conventional electron emission display device, the luminance gradually drops as its driving time elapses. When the luminance drops, the brightness of the whole pixel portion decreases. Moreover, a brightness difference between pixels also decreases, adversely affecting the contrast of the display.

### SUMMARY OF CERTAIN INVENTIVE ASPECTS

One aspect of the invention provides an electron emission display device and a driving method thereof capable of elevating a luminance and enhancing the life of the device

Another aspect of the invention provides an electron emission display device comprising: a pixel configured to flow an emission current therein and emit light when a pixel voltage is applied thereto, wherein the electron emission display device has an initial pixel current set during manufacturing thereof; and a luminance adjusting circuit comprising: a determining circuit configured to determine whether a luminance compensation is needed, and a voltage adjusting circuit configured to adjust the pixel voltage to an adjusted voltage, thereby adjusting the emission current to an adjusted current, wherein the adjusted current is smaller than the initial pixel current.

The determining circuit may be configured to determine whether the emission current is lower than a reference value, and the adjusted current may be greater than the reference value. The luminance adjusting circuit may further comprise: a reference current generator configured to generate the reference value; and a comparator configured to make a comparison between the emission current and the reference value and to generate a signal based on the comparison. The device may further comprise a power supply unit configured to supply the adjusted voltage to the pixel.

The reference current generator may comprise a memory, which stores a plurality of values, and the reference current generator may be configured to select one of the plurality of values as the reference value to provide to the determining circuit. The reference current generator may be further configured to select the value in a predetermined order.

The adjusted current may be greater than the reference value by a predetermined difference. The determining circuit may be configured to measure the luminance of the electron emission display device and to compare the measured luminance with a reference luminance. The device may further comprise a memory storing an immediately previously adjusted current, and the adjusted current may be smaller than the immediately previously adjusted current. The adjusted current may be smaller than the immediately previously adjusted current by a predetermined difference. The memory may be configured to store the adjusted current as a new immediately previously adjusted current.

The voltage adjusting circuit may further comprise a circuit configured to calculate the adjusted voltage and a circuit configured to adjust the pixel voltage to the adjusted voltage. The luminance adjusting circuit may comprise one or more of subcircuits and chips.

Another aspect of the invention provides a method of driving an electron emission display device. The method comprises: providing an electron emission display device comprising a pixel configured to flow an emission current therein and emit light when a pixel voltage is applied thereto, wherein the electron emission display device has an initial pixel current set during manufacturing thereof; determining whether a luminance compensation is needed; and if a luminance compensation is needed, adjusting the pixel voltage to an adjusted voltage, thereby adjusting the emission current to an adjusted current, wherein the adjusted current is smaller than the initial pixel current.

Determining may comprise determining whether the emission current is lower than a reference value, and wherein the adjusted current is greater than the reference value. The adjusted current may be greater than the reference value by a predetermined difference. Determining may comprise measuring the luminance of the electron emission display device and comparing the measured luminance with a reference luminance.

The method may further comprise storing an immediately previously adjusted current in a memory, and the adjusted current may be smaller than the immediately previously adjusted current. The adjusted current may be smaller than the immediately previously adjusted current by a predetermined difference. The adjusted current may become an immediately previously adjusted current for the next adjusting the emission current. Determining and adjusting may be repeated at a predetermined time interval.

Another aspect of the invention provides an electron emission display device comprising: a pixel portion for displaying an image corresponding to voltages of a first electrode and a second electrode; a data driver for transferring a data signal to the first electrode; a scan driver for transferring a scan signal to the second electrode; a current measuring section for measuring an emission current flowing through the pixel portion; a power supply unit for outputting an electric drive source; and a voltage controller for changing a voltage of an electric drive source corresponding to the emission current measured by the current measuring section, wherein the voltage controller controls the emission current flowing through the pixel portion by the changed voltage of the electric drive source, so that a magnitude of the emission current is less than that of an initially set emission current.

Another aspect of the invention provides an electron emission display device for receiving data and scan signals and for displaying a gradation according to a voltage difference between the data and scan signals, comprising: a power supply unit for transferring a first electric drive source having a first voltage to the electron emission display device; a current measuring section for measuring a magnitude of an emission current flowing through the electron emission display device by the first electric drive source; a first voltage controller for changing a voltage of a first electric drive source to a second voltage when a magnitude difference between the emission current and the reference current is equal to or greater than a predetermined value in such a manner that the emission current flowing through the electron emission display device and the reference current are set to be different from each other according to the second voltage.

Yet another aspect of the invention provides a method for driving an electron emission display device, comprising the steps of: (i) measuring a luminance of a pixel portion, the pixel portion emitting light with a set luminance; and (ii) compensating the measured luminance of the pixel portion when a difference between the measured luminance of the pixel portion and the set luminance is equal to or greater than a predetermined value, so that the luminance of the pixel portion is lower than the set luminance.

### BRIEF DESCRIPTION OF THE DRAWINGS

These and/or other aspects and advantages of the invention will become apparent and more readily appreciated from the following description of the preferred embodiments, taken in conjunction with the accompanying drawings of which:

FIG. 1 is a block diagram showing a conventional electron emission display device;

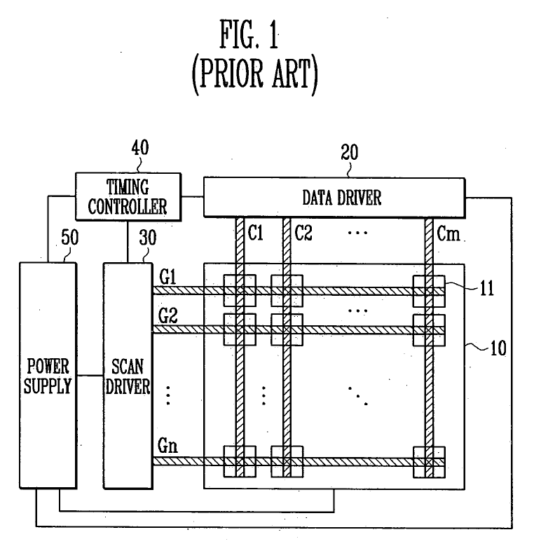

FIG. 2 is a block diagram showing an electron emission display device according to an embodiment;

FIG. 3A and FIG. 3B are views showing concepts for methods for compensating for a luminance in an electron emission display device according to an embodiment;

FIG. 4 is a block diagram showing an embodiment of a voltage controller of the electron emission display device of FIG. 2;

FIG. 5 is a schematic perspective view showing an embodiment of a pixel portion of the electron emission display device of FIG. 2; and

FIG. 6 is a schematic cross-sectional view of the pixel portion of FIG. 5.

### DETAILED DESCRIPTION OF CERTAIN INVENTIVE EMBODIMENTS

Hereinafter, embodiments according to the invention will be described with reference to the accompanying drawings. When one element is connected to another element, one element may be either directly connected to another element or indirectly connected to another element via a third element. In the drawings, like reference numerals indicate identical or functionally similar elements.

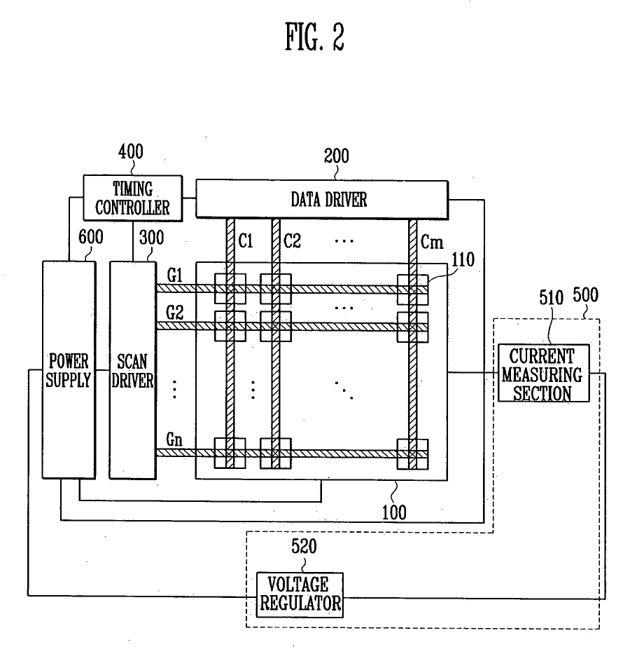

FIG. 2 is a block diagram showing an electron emission display device according to an embodiment. With reference to FIG. 2, the electron emission display device includes a pixel portion 100, a data driver 200, a scan driver 300, a timing controller 400, a voltage controller 500, and a power supply unit 600.

The pixel portion 100 includes pixels 101. In the pixel portion 100, a plurality of cathode electrodes C1, C2 . . . , Cn are arranged in a row direction. A plurality of gate electrodes G1, G2 . . . , Gn are arranged in a column direction. Electron emission sections are provided at intersections between the cathode electrodes C1, C2 . . . , Cn and the gate electrodes G1, G2 . . . , Gn. Alternatively, the cathode electrodes C1, C2 . . . , Cn and the gate electrodes G1, G2 . . . , Gn may be arranged in column and row directions, respectively. In the illustrated embodiment, the cathode electrodes C1, C2 . . . , Cn are arranged in a row direction, and the gate electrodes G1, G2 . . . , Gn are arranged in a column direction. When a luminance is deteriorated as driving time elapses, the pixel portion 100 adjusts a voltage difference between a cathode electrode and a gate electrode, so that the electron emission section emits more electrons to compensate for the luminance drop.

Furthermore, a fluorescent film and an anode electrode are formed over an entire surface of the pixel portion 100. An anode voltage is applied to the anode electrode. Electrons emitted from the electron emission sections by the anode voltage collide with the fluorescent film, thus emitting light.

The data driver 200 generates a data signal using an image signal, and transmits the data signal to the cathode electrodes C1, C2 . . . , Cn. The data driver 200 generates an electrode signal for turning on/off the pixels 101 formed at intersections between the cathode electrodes C1, C2 . . . , Cn and the gate electrodes G1, G2 . . . , Gn.

The scan driver 300 is connected to the gate electrodes G1, G2 . . . , Gn and, selects one of the plurality of the gate electrodes G1, G2 . . . , Gn, and transmits the data signal to the pixel portions 101 connected to the selected gate electrode.

The timing controller 400 transmits a data driver control signal and a scan driver control signal to the data driver 200 and the scan driver 300 to control the data driver 200 and the scan driver 300, respectively.

The voltage controller 500 is configured to measure an emission current flowing through the pixel portion 100. The voltage controller 500 is also configured to control a voltage of an electric drive source outputted from the power supply unit 600 based on a magnitude of the emission current.

The voltage controller 500 includes a current measuring section 510 and a voltage regulator 520. The current measuring section 510 measures the emission current. The voltage regulator 520 regulates the voltage of an electric drive source outputted from the power supply unit 600.

The voltage regulator 520 is configured to compare the emission current with a reference current. When a difference between the emission current and the reference current is equal to or greater than a predetermined value, the voltage regulator 520 increases the voltage of an electric drive source outputted from the power supply unit 600. In the illustrated embodiment, the voltage of the electric drive source is increased so that the emission current increases to a predetermined level which is lower than the reference current. In addition, the increased emission current is set as a reference current for use in a later voltage adjustment.

The power supply unit 600 generates and transmits the electric drive source to the data driver 200 and the scan driver 300 to drive the pixels, thereby displaying an image. The electric drive source generated by the power supply unit 600 may be divided into an anode source to be transferred to the pixel portion 100 and an electric drive source to be transferred to the data driver 200, the scan driver 300, and the timing controller 400.

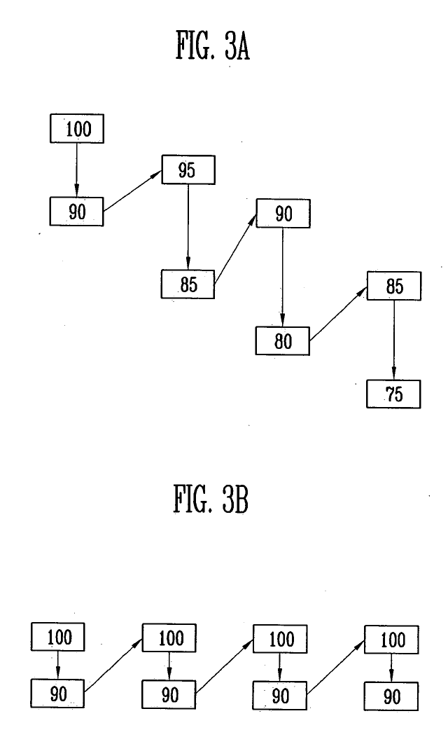

FIG. 3A and FIG. 3B are views showing methods for compensating for a luminance drop in an electron emission display device. FIG. 3A shows a method for compensating the luminance to a value less than an initial value when the luminance is lowered by a value equal to or greater than a predetermined value. FIG. 3B shows a method for compensating the luminance to an initial value when the luminance is lowered by a value equal to or greater than a predetermined value. In FIGS. 3A and 3B, it is assumed that an initial pixel emits light with a luminance of 100 and the luminance decreases as the driving time elapses. It is also assumed that the luminance is compensated when a difference between the initial luminance and the current luminance is equal to about 10. In other embodiments, the luminance may be compensated when the difference is equal to or greater than another predetermined value. In certain embodiments, the luminance may be measured using the emission current from the pixel.

In FIG. 3A, the initial luminance is 100. A variation of the luminance is sensed to determine whether a compensation is required. In one embodiment, the luminance is measured every time the electron emission device is operated. In certain embodiments, the luminance measurement may be conducted at a predetermined driving time interval, for example, every 5 hours, every 10 hours, every 50 hours, every 100 hours, every 500 hours, or every 1000 hours. A skilled artisan will appreciate that various time intervals can be employed depending on the design of the electron emission device.

When the luminance of the initial pixel and the luminance of the current pixel have a difference less than 10, the luminance is not compensated. On the other hand, when the luminance of the initial pixel and the luminance of the current pixel have a difference equal to or greater than 10, the luminance is compensated. In the illustrated embodiment, when the luminance is lowered to a value equal to or less than 90, the luminance is compensated. The luminance is increased to a value of about 95, but not the initial luminance value, 100.

After the luminance is compensated to 95, the reference luminance is set to 95. With reference to this new reference luminance, a variation of the luminance is sensed. When a difference between the current luminance and the reference luminance is equal to or greater than 10, (i.e., the current luminance is less than 85), the luminance is compensated to another value, 90. Further, the reference luminance is set to 90. Such steps are repeated to compensate the luminance of the pixel.

In FIG. 3B, the initial luminance is 100. A variation of the luminance is sensed to determine if a compensation is required. When the luminance of the initial pixel and the luminance of the current pixel have a difference less than 10, the luminance is not compensated. When the luminance of the initial pixel and the luminance of the current pixel have a difference equal to or greater than 10, the luminance is compensated. In the illustrated embodiment, the luminance is compensated to the luminance value of the initial pixel, 100.

After the luminance has been compensated to the initial value of 100, a variation of the luminance is sensed again after a predetermined period of time elapses. If the luminance of the pixel is equal to or lower than 90, the luminance is again compensated to 100, the initial value. Such steps are repeated to compensate the luminance of the pixel.

Unlike the method shown in FIG. 3B, in the method of FIG. 3A, the luminance of the pixel is compensated to a value less than the luminance of the initial pixel. Consequently, the method of FIG. 3A has a smaller increase in the drive voltage than the method of FIG. 3B. When the luminance compensation has been performed a number of times, a voltage difference of an electric drive source between the methods of FIGS. 3A and 3B is substantial. In other words, since the method of FIG. 3B needs an electric drive source greater than that of the method of FIG. 3A, the power supply unit should have a greater output. Furthermore, since the method of FIG. 3A uses a lower voltage level of an electric drive source than the method shown in FIG. 3B, it can compensate for the luminance drop with a less drive voltage increase. Accordingly, the method of FIG. 3A reduces a stress due to a voltage increase from a voltage emission section. Thus, the lifetime of the electron emission display device may be further enhanced. Moreover, a difference between an initial luminance value and a compensated luminance value is not great, and thus a user does not feel a visible difference.

The luminance compensation may become unavailable when the drive voltage cannot further be increased. The drive voltage cannot further be increased when it reaches the maximum voltage supplied to the electron emission device. In the method of FIG. 3B, when the luminance cannot be further compensated, the luminance rapidly drops from 100, the initial reference value. On the other hand, in the method shown in FIG. 3A, the luminance is gradually and repeatedly lowered to a lower reference value. Thus, when the luminance cannot be further compensated and thus the luminance begins to drop, a user feels a less difference than the method of FIG. 3B.

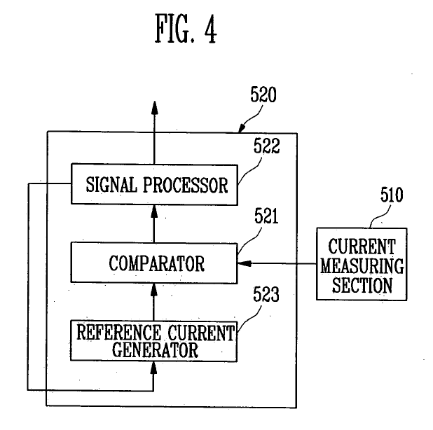

FIG. 4 is a block diagram showing an example of a voltage controller 500 of the electron emission display device shown in FIG. 2. Referring to FIG. 4, the voltage controller 500 includes a current measuring section 510 and a voltage regulator 520. The voltage regulator 520 includes a comparator 521, a signal processor 522, and a reference current generator 523.

The current measuring section 510 measures an emission current flowing through the pixel portion 100 and transmits the measured emission current to the voltage regulator 520. In the illustrated embodiment, the current measuring section 510 may measure the emission current flowing through the pixel portion 100 at only special times by periodically measuring the emission current. In other embodiments, the current measuring section 510 may measure the emission current every time and transmit it to the voltage regulator 520.

The comparator 521 compares the measured emission current measured with a reference current stored in the reference current generator 523. When a difference between the measured emission current and the reference current is equal to or greater than a predetermined value, the comparator 521 compensates for a magnitude of an electric drive source to compensate for the emission current drop.

The signal processor 522 transmits a voltage control signal corresponding to an output signal of the comparator 521. In response to the voltage control signal, the power supply unit 600 adjusts a voltage level of the electric drive source and transmits it to respective drivers.

When a large amount of the emission current flows, the electron emission display device expresses a higher luminance. On the other hand, when a small amount of the emission current flows, the electron emission display device expresses a lower luminance. Accordingly, when a magnitude of the measured emission current becomes small, the luminance becomes low. Consequently, the signal processor 522 increases a voltage of an electric drive source to increase the magnitude of the emission current. At this time, by adjusting the emission current to a value less than the initial emission current, the luminance comes to have a value lower than an initial luminance. Thus, the compensated luminance is darker than the initial luminance.

The reference current generator 523 generates and transmits a reference current to the comparator 521 so that the comparator 521 compares the measured current with the reference current. The reference current generator 523 includes a memory for storing a reference signal corresponding to the reference current. The reference current generator 523 transmits the reference signal stored in the memory to the comparator 521, which corresponds to the reference current. In the illustrated embodiment, the memory stores a plurality of reference signals corresponding to various voltages. The reference current generator 523 may select and transmits one of the reference signals to the comparator 521. Furthermore, when the voltage regulator 520 regulates a voltage, the reference current generator 523 may select and transmits a reference signal from the reference signals stored in the memory corresponding to the voltage regulated by the voltage regulator 520 to the comparator 521.

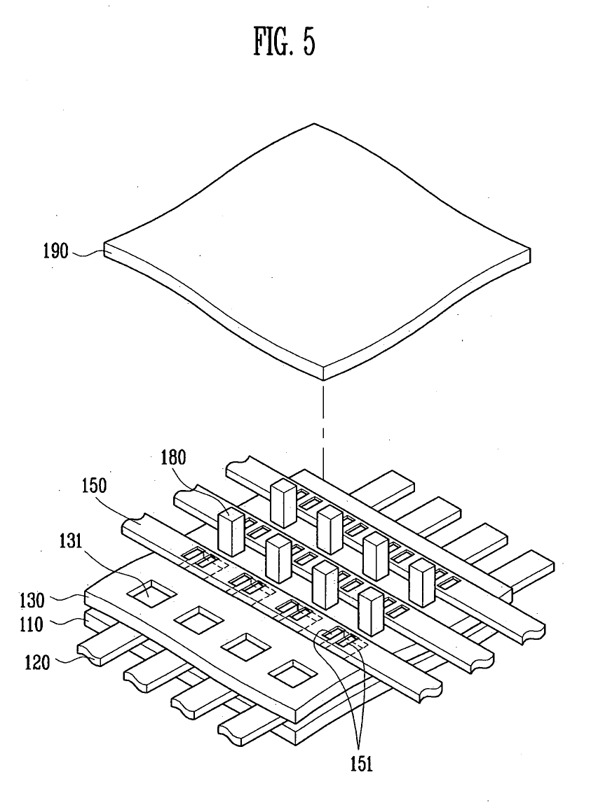

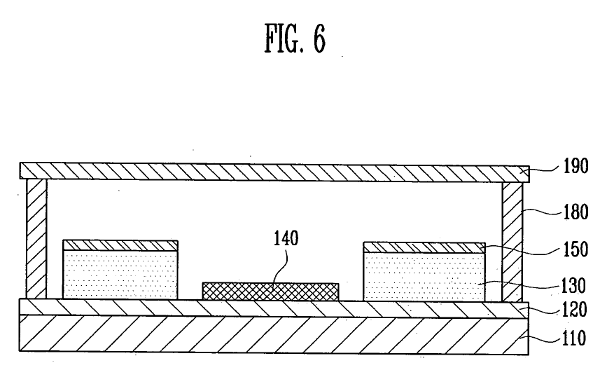

FIG. 5 is a perspective view showing an example of a pixel portion of the electron emission display device shown in FIG. 2. FIG. 6 is a cross-sectional view of the pixel portion shown in FIG. 5. With reference to FIGS. 5 and 6, the electron emission display device includes a lower substrate 110, an upper substrate 190, and a spacer 180. A cathode electrode 120, an insulation layer 130, an electron emission portion 140, and a gate electrode 150 are successively formed on the lower substrate 110. A front substrate, an anode electrode, and a fluorescent filn are formed on the upper substrate 190.

At least one cathode electrode 120 is formed on the lower substrate 110 in a stripe pattern, and the insulation layer 130 is formed at an upper portion of the cathode electrode 120. A plurality of first grooves 131 are formed at the insulation layer 130 exposing a part of the cathode electrode 120. The gate electrode 150 is formed at an upper portion of the insulation layer 130. A plurality of second grooves 151 having a predetermined size are formed at the gate electrode 150. The second grooves 151 are formed at upper portions of the first grooves 131. An electron emission portion 140 is disposed in a region in which the first groove 131 and the second groove 151 correspond to each other at an upper portion of the cathode electrode 120.

A glass or silicon substrate is used as the lower substrate 110. When forming the electron emission portion 140 by a rear surface exposure using paste, a transparent substrate such as the glass substrate may be used as the lower substrate 110.

The cathode electrode 120 provides the data signal and the scan signal from the data driver (not shown) and the scan driver (not shown) to the electron emission portion 140. An indium tin oxide (ITO) is utilized as the cathode electrode 120.

The insulation layer 130 is formed at an upper portion of the cathode electrode 120, which is formed on the lower substrate 110. The insulation layer 130 electrically insulates the cathode electrode 120 and the gate electrode 150 from each other.

The gate electrode 150 is formed on the insulation layer 130 to intersect the cathode electrode 120 in a stripe pattern. The gate electrode 150 provides the data signal and the scan signal from the data driver 200 and the scan driver 300 to respective pixels. The gate electrode 150 may include at least one conductive metal material selected from the group consisting gold (Au), silver (Ag), platinum (Pt), aluminum (Al), chromium (Cr), and an alloy of two or more of the foregoing, which are excellent conductors.

The electron emission portion 140 is electrically connected to the cathode electrode 120 exposed by the first opening 131 of the insulation layer 130. The electron emission portion 140 may include materials which can emit electrons when an electric field is applied thereto. Examples of the materials include carbon system materials, carbon system nano size materials, carbon nano tube, graphite, graphite nano fiber, carbon on diamond, C60, silicon nano wire, or a combination thereof.

The upper substrate 190 includes a fluorescent film. When electrons collide with the fluorescent film of the upper substrate 190, the upper substrate 190 emits light. The upper substrate 190 includes an anode electrode. Electrons emitted from the electron emission portion may collide with the upper substrate. The spacer 180 provides a predetermined distance between the lower substrate 110 and the upper substrate 190.

Although a few embodiments of the invention have been shown and described, it would be appreciated by those skilled in the art that changes might be made in this embodiment without departing from the principles and spirit of the invention, the scope of which is defined in the claims and their equivalents.

What is claimed is:

1. An electron emission display device comprising:
a pixel configured to flow an emission current therein and emit light when a pixel voltage is applied thereto, wherein the electron emission display device has an initial pixel current set during manufacturing thereof; and
a luminance adjusting circuit comprising:
a determining circuit configured to determine whether a luminance compensation is needed, and
a voltage adjusting circuit configured to adjust the pixel voltage to an adjusted voltage, thereby adjusting the emission current to an adjusted current, wherein the adjusted current is smaller than the initial pixel current.

2. The device of claim 1, wherein the determining circuit is configured to determine whether the emission current is lower than a reference value, and wherein the adjusted current is greater than the reference value.

3. The device of claim 2, wherein the luminance adjusting circuit further comprises:
a reference current generator configured to generate the reference value; and
a comparator configured to make a comparison between the emission current and the reference value and to generate a signal based on the comparison.

4. The device of claim 3, further comprising a power supply unit configured to supply the adjusted voltage to the pixel.

5. The device of claim 3, wherein the reference current generator comprises a memory, which stores a plurality of values, wherein the reference current generator is configured to select one of the plurality of values as the reference value to provide to the determining circuit, and wherein the reference current generator is further configured to select the value in a predetermined order.

6. The device of claim 2, wherein the adjusted current is greater than the reference value by a predetermined difference.

7. The device of claim 1, wherein the determining circuit is configured to measure the luminance of the electron emission display device and to compare the measured luminance with a reference luminance.

8. The device of claim 1, further comprising a memory storing an immediately previously adjusted current, wherein the adjusted current is smaller than the immediately previously adjusted current.

9. The device of claim 8, wherein the adjusted current is smaller than the immediately previously adjusted current by a predetermined difference.

10. The device of claim 8, wherein the memory is configured to store the adjusted current as a new immediately previously adjusted current.

11. The device of claim 1, wherein the voltage adjusting circuit firther comprises a circuit configured to calculate the adjusted voltage and a circuit configured to adjust the pixel voltage to the adjusted voltage.

12. The device of claim 1, wherein the luminance adjusting circuit comprises one or more of subcircuits and chips.

13. A method of driving an electron emission display device, the method comprising:
providing an electron emission display device comprising a pixel configured to flow an emission current therein and emit light when a pixel voltage is applied thereto, wherein the electron emission display device has an initial pixel current set during manufacturing thereof;
determining whether a luminance compensation is needed; and
if a luminance compensation is needed, adjusting the pixel voltage to an adjusted voltage, thereby adjusting the emission current to an adjusted current, wherein the adjusted current is smaller than the initial pixel current.

14. The method of claim 13, wherein determining comprises determining whether the emission current is lower than a reference value, and wherein the adjusted current is greater than the reference value.

15. The method of claim 14, wherein the adjusted current is greater than the reference value by a predetermined difference.

16. The method of claim 13, wherein determining comprises measuring the luminance of the electron emission display device and comparing the measured luminance with a reference luminance.

17. The method of claim 13, further comprising storing an immediately previously adjusted current in a memory, wherein the adjusted current is smaller than the immediately previously adjusted current.

18. The method of claim 17, wherein the adjusted current is smaller than the immediately previously adjusted current by a predetermined difference.

19. The method of claim 17, wherein the adjusted current becomes an immediately previously adjusted current for the next adjusting the emission current.

20. The method of claim 13, wherein determining and adjusting are repeated at a predetermined time interval.
